(19) United States
(12) Patent Application Publication
(10) Pub. No.: US 2013/0050150 A1
(43) Pub. Date: Feb. 28, 2013

(54) HANDHELD ELECTRONIC DEVICE

(71) Applicants: Yao-Tsung Chang, New Taipei City (TW); Chia-Hsien Li, New Taipei City (TW)

(72) Inventors: Yao-Tsung Chang, New Taipei City (TW); Chia-Hsien Li, New Taipei City (TW)

(21) Appl. No.: 13/545,013

(22) Filed: Jul. 10, 2012

(30) Foreign Application Priority Data
Aug. 22, 2011 (TW) 100130010

(51) Int. Cl. G06F 3/042

(52) U.S. Cl. 345/176

(57) ABSTRACT

A handheld electronic device includes a casing, a transparent display panel and a transparent touch panel. The transparent display panel is disposed on the casing and has a viewing side and a non-viewing side opposite to the viewing side. The transparent touch panel is disposed on the casing and on the non-viewing side of the transparent display panel. When a user holds the handheld electronic device by a hand, the user can view the hand, which performs touch action on the transparent touch panel, through the transparent display panel and the transparent touch panel.

### BACKGROUND OF THE INVENTION

1. Field of the Invention

The invention relates to a handheld electronic device and, more particularly, to a handheld electronic device with a touch panel or touch device disposed on a non-viewing side of a display panel.

2. Description of the Prior Art

Since consumer electronic products have become more and more lighter, thinner, shorter, and smaller, there is no space on these products for containing a conventional input device, such as a mouse, a keyboard, etc. With development of touch technology, in various kinds of consumer electronic products (e.g. a tablet personal computer, a mobile phone, or a personal digital assistant (PDA)), a touch panel has become a main tool for data input. In general, the touch panel can be operated by common users conveniently. However, when a user operates the touch panel by his/her hand, a gesture performed by the user always hinders the user from viewing a display panel since the touch panel is always disposed over a viewing side of the display panel. Furthermore, the touch panel may get dirty easily after being operated by the user for a long time so that it may also disturb the user from viewing the display panel.

### SUMMARY OF THE INVENTION

The invention provides a handheld electronic device with a touch panel or touch device disposed on a non-viewing side of a display panel so as to solve the aforesaid problems.

According to an embodiment, a handheld electronic device of the invention comprises a casing, a transparent display panel and a transparent touch panel. The transparent display panel is disposed on the casing. The transparent display panel has a viewing side and a non-viewing side opposite to the viewing side. The transparent touch panel is disposed on the casing and on the non-viewing side of the transparent display panel. When a user holds the handheld electronic device by a hand, the user views the hand, which performs a touch action (e.g. contact or press) on the transparent touch panel, through the transparent display panel and the transparent touch panel.

Since the touch action is performed at the non-viewing side of the transparent display panel, it will not hinder the user from viewing the viewing side of the transparent display panel and will not make the viewing side of the transparent display panel get dirty.

According to another embodiment, a handheld electronic device of the invention comprises a casing, a non-transparent display panel and a touch device. The non-transparent display panel is disposed on the casing. The non-transparent display panel has a viewing side and a non-viewing side opposite to the viewing side. The touch device is disposed on the casing and on the non-viewing side of the non-transparent display panel. In this embodiment, the handheld electronic device may further comprise a processing unit and a memory unit. The processing unit and the memory unit are disposed in the casing. The processing unit is electrically connected to the non-transparent display panel, the touch device and the memory unit. The memory unit is used for storing a gesture simulating program. When a user holds the handheld electronic device by a hand, the processing unit executes the gesture simulating program so as to control the non-transparent display panel to display a virtual gesture corresponding to the hand according to a position where the hand touches the touch device.

Since the touch action is performed at the non-viewing side of the non-transparent display panel, it will not hinder the user from viewing the viewing side of the non-transparent display panel and will not make the viewing side of the non-transparent display panel get dirty. Furthermore, since the user cannot view the hand while operating the touch device, the invention utilizes the gesture simulating program to display the virtual gesture corresponding to the hand on the viewing side of the non-transparent display panel. Therefore, the user can perform touch functions on the touch device conveniently according to the virtual gesture.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a handheld electronic device according to an embodiment of the invention.

FIG. 2 is a schematic diagram illustrating a side view of the handheld electronic device shown in FIG. 1.

FIG. 3 is a functional block diagram illustrating the handheld electronic device shown in FIG. 1.

FIG. 4 is a schematic diagram illustrating a handheld electronic device according to another embodiment of the invention.

FIG. 5 is a schematic diagram illustrating a side view of the handheld electronic device shown in FIG. 4.

FIG. 6 is a functional block diagram illustrating the handheld electronic device shown in FIG. 4.

FIG. 7 is a schematic diagram illustrating a side view of the touch device shown in FIG. 5.

### DETAILED DESCRIPTION

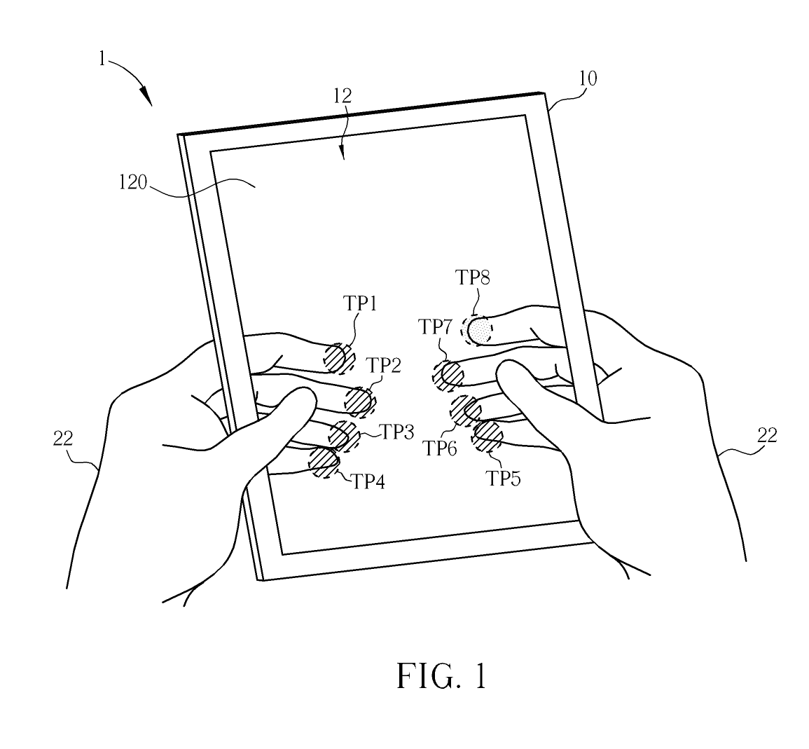

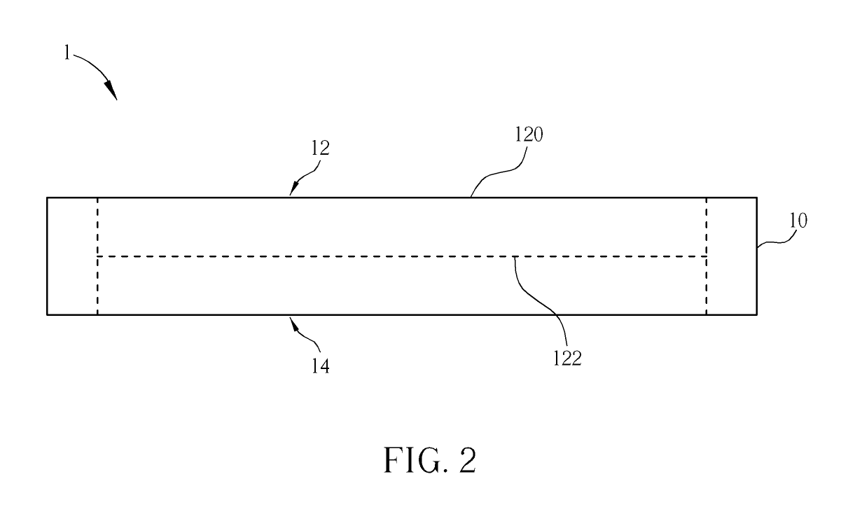

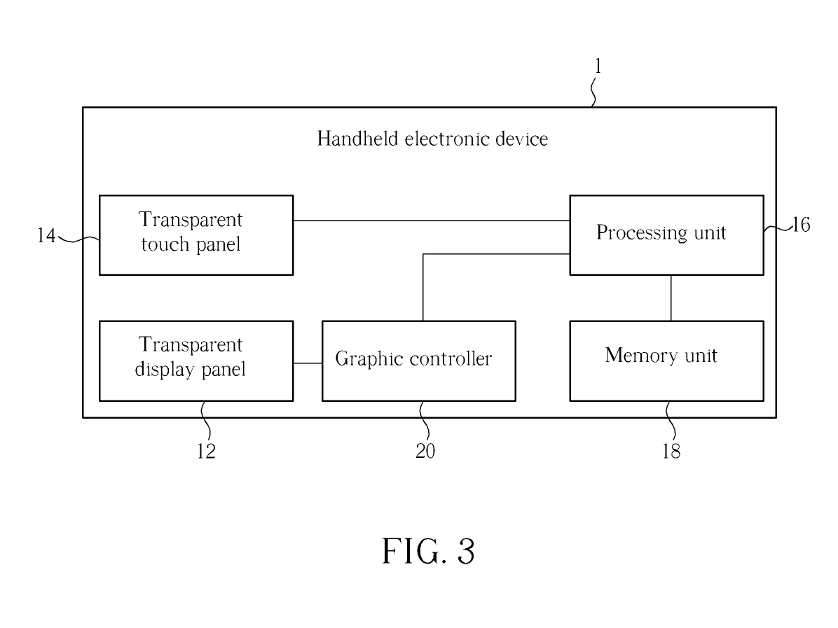

Referring to FIGS. 1 to 3, FIG. 1 is a schematic diagram illustrating a handheld electronic device 1 according to an embodiment of the invention, FIG. 2 is a schematic diagram illustrating a side view of the handheld electronic device 1 shown in FIG. 1, and FIG. 3 is a functional block diagram illustrating the handheld electronic device 1 shown in FIG. 1. As shown in FIGS. 1 to 3, the handheld electronic device 1 comprises a casing 10, a transparent display panel 12, a transparent touch panel 14, a processing unit 16, a memory unit 18 and a graphic controller 20. In this embodiment, the handheld electronic device 1 maybe a tablet personal computer, a mobile phone, a personal digital assistant, etc, the transparent display panel 12 may be a transparent liquid crystal display or other transparent displays, the transparent touch panel 14 may be a piezoelectric, resistance, or capacitance type transparent touch panel, the processing unit 16 may be a processor capable of calculating and processing data, and the memory unit 18 may be a non-volatile memory or other data storage devices.

The transparent display panel 12 is disposed on the casing 10. The transparent display panel 12 has a viewing side 120 and a non-viewing side 122 opposite to the viewing side 120. A user can view a screen in front of the viewing side 120 of the transparent display panel 12. The transparent touch panel 14 is disposed on the casing 10 and on the non-viewing side 122 of the transparent display panel 12. In this embodiment, the transparent touch panel 14 is disposed at, but not limited to, the back of the casing 10. The processing unit 16 and the memory unit 18 are disposed in the casing 10. The processing unit 16 is electrically connected to the transparent touch panel 14, the memory unit 18 and the graphic controller 20 and is electrically connected to the transparent display panel 12 through the graphic controller 20. In this embodiment, the transparent display panel 12 is used for displaying images; the transparent touch panel 14 is used for sensing touch action (e.g. contact or press) performed by a user; the processing unit 16 is used for executing programs stored in the memory unit 18, receiving touch signals from the transparent touch panel 14, and controlling the graphic controller 20 to display images on the transparent display panel 12; the memory unit 18 is used for storing programs and data required by the handheld electronic device 1; and the graphic controller 20 is used for generating images and then displaying the images on the transparent display panel 12.

As shown in FIG. 1, when a user holds the handheld electronic device 1 by hands 22, the user can view the hands 22, which perform a touch action (e.g. contact or press) on the transparent touch panel 14, through the transparent display panel 12 and the transparent touch panel 14.

In this embodiment, when the processing unit 16 determines that the touch action is a contact action, the processing unit 16 controls the transparent display panel 12 to display contact positions TP1-TP8 corresponding to the contact action through the graphic controller 20. When the processing unit 16 determines that the touch action is a press action, the processing unit 16 controls the transparent display panel 12 to display an execution result of a command corresponding to the press action. As shown in FIG. 1, the contact position T8 is pressed by the user and is displayed by a specific cursor so as to be distinguished from other contact positions TP1-TP7. As to the determination of the aforesaid contact action and press action, it can be referred to Taiwan patent publication No. 201113769 and will not be depicted herein.

Furthermore, the memory unit 18 may store N gesture patterns and N commands corresponding to the N gesture patterns, wherein N is a positive integer. As shown in the following table 1, table 1 records six gesture patterns and six commands corresponding to the six gesture patterns. It should be noted that the number of the gesture patterns and the commands and the relation thereof can be determined based on practical applications and it is not limited to the embodiment listed in table 1. When the processing unit 16 determines that the touch action is a press action, the processing unit 16 collects an operation gesture performed by the user on the transparent touch panel 14 after the press action and then determines whether the operation gesture conforms to one of the N gesture patterns. If the operation gesture conforms to one of the N gesture patterns, the processing unit 16 executes one of the N commands correspondingly. For example, if the operation gesture performed by the user on the transparent touch panel 14 after the press action is represented as “→” (i.e. the finger of the user slides rightward on the transparent touch panel 14), the processing unit 16 will control the screen of the transparent display panel 12 to slide rightward; if the operation gesture performed by the user on the transparent touch panel 14 after the press action is represented as “X” (i.e. the finger of the user draws “X” on the transparent touch panel 14), the processing unit 16 will close a window displayed on the transparent display panel 12. On the other hand, if the operation gesture performed by the user on the transparent touch panel 14 after the press action does not conform to any one of the gesture patterns, the processing unit 16 will not execute any commands.

TABLE 1

| Gesture pattern | Command |
|---|---|
| O | Open main menu |
| X | Close window |
| → | Slide screen rightward |
| ← | Slide screen leftward |
| ↑ | Page up |
| ↓ | Page down |

As mentioned above, since the touch action is performed at the non-viewing side 122 of the transparent display panel 12, the hand of the user will not hinder the user from viewing the viewing side 120 of the transparent display panel 12 and will not make the viewing side 120 of the transparent display panel 12 get dirty.

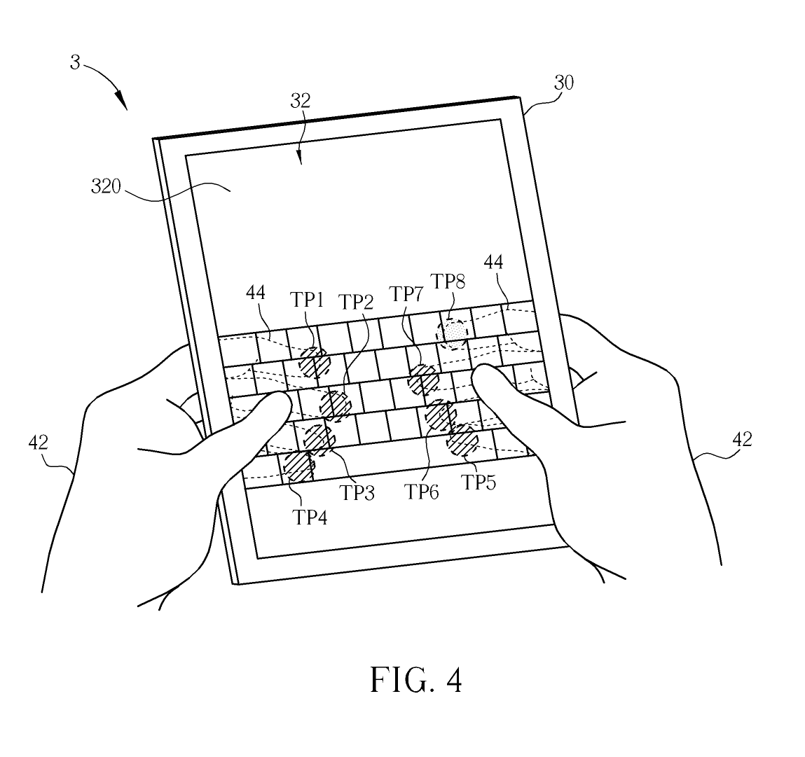

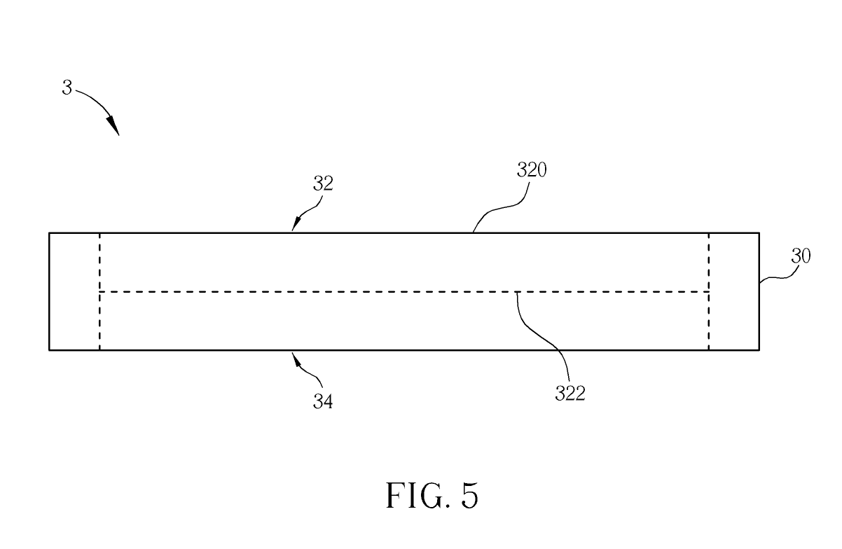

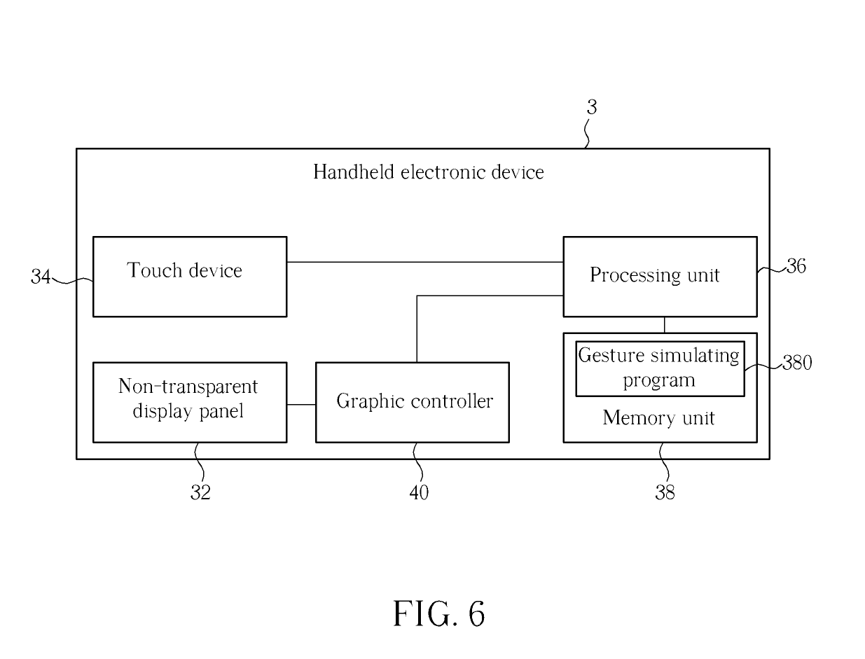

Referring to FIGS. 4 to 6, FIG. 4 is a schematic diagram illustrating a handheld electronic device 3 according to another embodiment of the invention, FIG. 5 is a schematic diagram illustrating a side view of the handheld electronic device 3 shown in FIG. 4, and FIG. 6 is a functional block diagram illustrating the handheld electronic device 3 shown in FIG. 4. As shown in FIGS. 4 to 6, the handheld electronic device 3 comprises a casing 30, a non-transparent display panel 32, a touch device 34, a processing unit 36, a memory unit 38 and a graphic controller 40. In this embodiment, the handheld electronic device 3 maybe a tablet personal computer, a mobile phone, a personal digital assistant, etc, the non-transparent display panel 32 may be a liquid crystal display or other transparent displays, the touch device 34 maybe a piezoelectric, resistance, or capacitance type touch device, the processing unit 36 may be a processor capable of calculating and processing data, and the memory unit 38 may be a non-volatile memory or other data storage devices.

The non-transparent display panel 32 is disposed on the casing 30. The non-transparent display panel 32 has a viewing side 320 and a non-viewing side 322 opposite to the viewing side 320. A user can view a screen in front of the viewing side 320 of the transparent display panel 32. The touch device 34 is disposed on the casing 30 and on the non-viewing side 322 of the non-transparent display panel 32. In this embodiment, the touch device 34 is disposed at, but not limited to, the back of the casing 30. The processing unit 36 and the memory unit 38 are disposed in the casing 30. The processing unit 36 is electrically connected to the touch device 34, the memory unit 38 and the graphic controller 40 and is electrically connected to the non-transparent display panel 32 through the graphic controller 40. In this embodiment, the non-transparent display panel 32 is used for displaying images; the touch device 34 is used for sensing touch action (e.g. contact or press) performed by a user; the processing unit 36 is used for executing programs stored in the memory unit 38, receiving touch signals from the touch device 34, and controlling the graphic controller 40 to display images on the non-transparent display panel 32; the memory unit 38 is used for storing programs and data required by the handheld electronic device 3; and the graphic controller 40 is used for generating images and then displaying the images on the non-transparent display panel 32.

Since the user cannot view the hand while operating the touch device 34, the invention stores a gesture simulating program 380 in the memory unit 38. As shown in FIG. 4, when the user holds the handheld electronic device 3 by hands 42, the processing unit 36 executes the gesture simulating program 380 so as to control the non-transparent display panel 32 to display a virtual gesture 44, which is represented by the dotted line, corresponding to the hands 42 according to positions where the hands 42 touch the touch device 34. In this embodiment, the virtual gesture 44 corresponding to the hands 42 maybe formed by extending the positions TP1-TP8 to opposite sides of the casing 30 rightward and leftward. Therefore, the user can perform touch functions on the touch device 34 conveniently according to the virtual gesture 44. It should be noted that the invention may generate the virtual gesture 44 by other algorithms and it is not limited to the aforesaid embodiment.

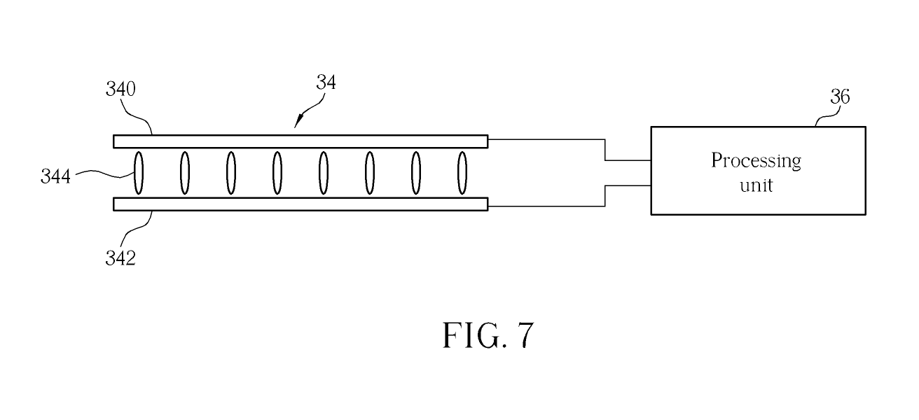

Referring to FIG. 7, FIG. 7 is a schematic diagram illustrating a side view of the touch device 34 shown in FIG. 5. As shown in FIG. 7, the touch device 34 may comprise an upper conductive layer 340, a lower conductive layer 342 and spacers 344 disposed between the upper and lower conductive layers 340, 342. Since the touch device 34 can be disposed at the back of the casing 30, the touch device can be made of other inexpensive materials instead of Indium Tin Oxide (ITO) so as to save manufacture cost. Furthermore, the lower conductive layer 342 may be a back casing of the casing 30. That is to say, the lower conductive layer 342 may be replaced by the back casing of the casing 30 so as to reduce the thickness of the handheld electronic device 3. Moreover, the spacers 344 may be formed on the back casing of the casing 30.

In this embodiment, when the processing unit 36 determines that a touch action, which a user performs on the touch device 34, is a contact action, the processing unit 36 controls the non-transparent display panel 32 to display contact positions TP1-TP8 corresponding to the contact action through the graphic controller 40. When the processing unit 36 determines that the touch action is a press action, the processing unit 36 controls the non-transparent display panel 32 to display an execution result of a command corresponding to the press action. As shown in FIG. 4, the contact position T8 is pressed by the user and is displayed by a specific cursor so as to be distinguished from other contact positions TP1-TP7. As to the determination of the aforesaid contact action and press action, it can be referred to Taiwan patent publication No. 201113769 and will not be depicted herein.

Furthermore, the memory unit 38 may store N gesture patterns and N commands corresponding to the N gesture patterns, wherein N is a positive integer. As shown in the above table 1, table 1 records six gesture patterns and six commands corresponding to the six gesture patterns. It should be noted that the number of the gesture patterns and the commands and the relation thereof can be determined based on practical applications and it is not limited to the embodiment listed in table 1. When the processing unit 36 determines that the touch action is a press action, the processing unit 36 collects an operation gesture performed by the user on the touch device 34 after the press action and then determines whether the operation gesture conforms to one of the N gesture patterns. If the operation gesture conforms to one of the N gesture patterns, the processing unit 36 executes one of the N commands correspondingly. For example, if the operation gesture performed by the user on the touch device 34 after the press action is represented as “↓” (i.e. the finger of the user slides downward on the touch device 34), the processing unit 36 will control the screen of the non-transparent display panel 32 to page down; if the operation gesture performed by the user on the transparent touch panel 14 after the press action is represented as “O” (i.e. the finger of the user draws “O” on the touch device 34), the processing unit 36 will open main menu on the non-transparent display panel 32. On the other hand, if the operation gesture performed by the user on the touch device 34 after the press action does not conform to any one of the gesture patterns, the processing unit 36 will not execute any commands.

As mentioned above, since the touch action is performed at the non-viewing side of the non-transparent display panel, the hand of the user will not hinder the user from viewing the viewing side of the non-transparent display panel and will not make the viewing side of the non-transparent display panel get dirty. Furthermore, since the user cannot view the hand while operating the touch device, the invention utilizes the gesture simulating program to display the virtual gesture corresponding to the hand on the viewing side of the non-transparent display panel. Therefore, the user can perform touch functions on the touch device conveniently according to the virtual gesture.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A handheld electronic device comprising:
a casing;
a transparent display panel disposed on the casing, the transparent display panel having a viewing side and a non-viewing side opposite to the viewing side; and
a transparent touch panel disposed on the casing and on the non-viewing side of the transparent display panel;
wherein when a user holds the handheld electronic device by a hand, the user views the hand, which performs a touch action on the transparent touch panel, through the transparent display panel and the transparent touch panel.

2. The handheld electronic device of claim 1, further comprising a processing unit disposed in the casing and electrically connected to the transparent display panel and the transparent touch panel.

3. The handheld electronic device of claim 2, wherein when the processing unit determines that the touch action is a contact action, the processing unit controls the transparent display panel to display a contact position corresponding to the contact action; when the processing unit determines that the touch action is a press action, the processing unit controls the transparent display panel to display an execution result of a command corresponding to the press action.

4. The handheld electronic device of claim 2, further comprising a memory unit disposed in the casing and electrically connected to the processing unit, the memory unit being used for storing N gesture patterns and N commands corresponding to the N gesture patterns, N being a positive integer, wherein when the processing unit determines that the touch action is a press action, the processing unit collects an operation gesture performed by the user on the transparent touch panel after the press action and then determines whether the operation gesture conforms to one of the N gesture patterns, if the operation gesture conforms to one of the N gesture patterns, the processing unit executes one of the N commands correspondingly.

5. A handheld electronic device comprising:
a casing;
a non-transparent display panel disposed on the casing, the non-transparent display panel having a viewing side and a non-viewing side opposite to the viewing side; and
a touch device disposed on the casing and on the non-viewing side of the non-transparent display panel.

6. The handheld electronic device of claim 5, further comprising:
a processing unit disposed in the casing and electrically connected to the non-transparent display panel and the touch device; and
a memory unit disposed in the casing and electrically connected to the processing unit, the memory unit being used for storing a gesture simulating program;
wherein when a user holds the handheld electronic device by a hand, the processing unit executes the gesture simulating program so as to control the non-transparent display panel to display a virtual gesture corresponding to the hand according to a position where the hand touches the touch device.

7. The handheld electronic device of claim 6, wherein when the processing unit determines that a touch action, which the user performs on the touch device, is a contact action, the processing unit controls the non-transparent display panel to display a contact position corresponding to the contact action; when the processing unit determines that the touch action is a press action, the processing unit controls the non-transparent display panel to display an execution result of a command corresponding to the press action.

8. The handheld electronic device of claim 6, wherein the memory unit further stores N gesture patterns and N commands corresponding to the N gesture patterns, N is a positive integer, when the processing unit determines that a touch action, which the user performs on the touch device, is a press action, the processing unit collects an operation gesture performed by the user on the touch device after the press action and then determines whether the operation gesture conforms to one of the N gesture patterns, if the operation gesture conforms to one of the N gesture patterns, the processing unit executes one of the N commands correspondingly.

9. The handheld electronic device of claim 5, wherein the touch device comprises an upper conductive layer, a lower conductive layer and a spacer disposed between the upper and lower conductive layers.

10. The handheld electronic device of claim 9, wherein the lower conductive layer is a back casing of the casing.

11. The handheld electronic device of claim 10, wherein the spacer is formed on the back casing.
